(19) United States
(12) Patent Application Publication
(10) Pub. No.: US 2009/0242452 A1
(43) Pub. Date: Oct. 1, 2009

(54) APPARATUSES AND METHODS FOR EASY READ RECOMMENDED DOSAGE REMINDER

(76) Inventor: Keith PERRY, Lodgepole, NE (US)

Correspondence Address: CONLEY ROSE, P.C.;David A. Rose, P. O. BOX 3267, HOUSTON, TX, 77253-3267, US

(21) Appl. No.: 12/411,498

(22) Filed: Mar. 26, 2009

Related U.S. Application Data
(60) Provisional application No. 61/039,848, filed on Mar. 27, 2008.

(51) Int. Cl. A61J 1/14; B65D 83/04

(52) U.S. Cl. 206/534; 220/200

(57) ABSTRACT

Embodiments provide apparatuses and methods for easy read recommended dosage reminder. In some embodiments, a closure for a container of ingestible product comprises a closure body configured and arranged to be removably mounted on a container, the closure body including a top surface. Indicia is formed as part of the closure body top surface, the indicia displaying a number of tablets to ingest and how many times per day the number of tablets are to be ingested. In other embodiments, a method for displaying indicia of dosing information for an ingestible product comprises providing indicia formed as part of a top surface of a closure body, the closure body configured and arranged to be removably mounted to a container, the indicia displaying a number of tablets to ingest and how many times per day the number of tablets are to be ingested, and displaying the indicia.

### CROSS-REFERENCE TO RELATED APPLICATION

The present application claims priority to U.S. provisional patent application Ser. No. 61/039,848, filed Mar. 27, 2008, and entitled “Easy Read Recommended Dosage Reminder a.k.a. How Many, How Often System”, hereby incorporated in its entirety herein by reference.

### BACKGROUND

Many people take medications or use dietary supplements and over-the-counter remedies. When taking any type of supplement, medication or other ingestible product, it is very important to use the recommended dosage to provide the benefit of the ingestible product without serious injury or death as result of overdose. Similarly, it is important to keep sufficient amounts of such ingestible products in one's blood stream to effect the desired results; thus, under-consumption may be a waste of money, a further deterioration of health, and/or an ineffective means to achieve the desired results.

To determine the proper dosage of a supplement, medication or other ingestible product, the user must locate the dosage information on the label, which is often difficult to find due to small print and/or being somewhat concealed by other information provided on the label. The dosage information for an ingestible product is among the most important information on a supplement level, and often is the main piece of information that users seek when reading the label.

Due to inattentiveness, a busy schedule, preoccupation with other matters, or a myriad of other reasons, it can be challenging to keep track of the recommended dosages of ingestible products. This situation is exacerbated when a single individual is taking multiple ingestible products or when one is caring for multiple individuals requiring multiple—and often varying—ingestible products.

Existing mechanical reminder devices incorporate indicators into closures invariably indicate time. For example, the indicator in such devices is set by the user or caregiver to the next time to take a tablet, or to indicate the last time a tablet was taken. As it turns out, many prescriptions for pills are written for a specific number of pills to be ingested a certain number of times a day. Similarly, dietary supplements and vitamins have recommended dosages based on a set number of pills to be ingested a certain number of times a day. In these cases—and others—rather than it being important to keep a strict time regime (e.g., medicine which must be taken every 4 or 6 hours) to maintain a certain level of, for example, medication in the blood stream, most ingestible products are to be taken a set number of pills a certain number of times a day. This type of dosing, i.e., number of tablets ingested a set number of times daily, is normally employed for at least two reasons. One, the human body absorbs the particular ingredients of the ingestible product at a rate that does not require strict attention to dosage timing to maintain a sufficient level of the ingredient(s) in the blood stream to effect the desired results. Another reason for this type of dosing is to spread out the absorption rate. For many supplements, etc. a lower level of supplement taken multiple times daily yields better results than a higher level of supplement taken once. As a result, there is less waste of supplement—frequently the human body can only assimilate a certain amount of, for example, a particular mineral at a set rate; any higher concentration of the particular mineral, in this example, is simply eliminated from the body as waste.

Dosage information on labels—particularly on over-the-counter remedies, vitamins, minerals, supplements and other dietary ingestible products—is provided along with other information such as percent composition of ingredients, percent active ingredients, etc. including numerical information any portion of which can, unfortunately, be easily confused with dosage information when a user glances at it. For example, it is easy for a user or caregiver to transpose numbers, or see a number that is not part of the dosage instructions and incorrectly assume it is the dosage. These common mistakes again hinder the user to quickly and easily determine the basic information of how much and how often to take the ingestible product.

Existing dosage reminder apparatuses depend for their effectiveness upon a user or caregiver's diligence and accuracy. For example, Seijas, U.S. Pat. No. 7,222,736 discloses a means to display medication regimen with a closure that mechanically shows the time of either the last or next dose. Such closure is intended to be a dosage reminder device, but it requires update by the user/caregiver and does not clearly show the basic information of how much to take, and when. Moreover, the additional effort to track the time of a previous or subsequent dosage is unnecessary for most ingestible products, and can be frustrating if the user or caregiver forgets to diligently and consistently update the closure.

Another effort to provide dosage assistance with a closure lid is Miller, U.S. Pat. 7,000,791, which is a vial closure using a rotating indicator to indicate the last dose taken. Again, such rotating indicator requires consistent update by the user and still does not clearly show the basic dosage information, i.e., how many tablets, how often daily.

Moreover, existing reminder mechanisms lack the necessary simplicity and low cost to be incorporated into the inexpensive packaging, such as would be used for common prescriptions, or the mass-manufactured packaging for supplements, vitamins and other ingestible products. Additionally, existing reminder mechanisms lack the ability to be easily adapted for both the simple snap-fit type and child-resistant type of caps.

### BRIEF DESCRIPTION OF THE DRAWINGS

For a detailed description of exemplary embodiments of the invention, reference will be made to the accompanying drawings in which:

FIGS. 1A-1C illustrate exemplary top plan views of ingestible container closures according to embodiments;

FIGS. 2A-2D illustrate exemplary methods of providing indicia on closures, according to embodiments; and

FIGS. 3A-3B illustrate an advantage of embodiments with respect to a plurality of containers, according to at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

### DETAILED DESCRIPTION

It should be understood at the outset that although exemplary implementations of embodiments of the disclosure are illustrated below, embodiments may be implemented using any number of techniques, whether currently known or in existence. This disclosure should in no way be limited to the exemplary implementations, drawings, and techniques illustrated below, including the exemplary design and implementation illustrated and described herein, but may be modified within the scope of the appended claims along with their full scope of equivalents.

It is to be appreciated that the term “user” is intended to subsume any individual opening at least one ingestible product container whether to dispense the contents to themselves or to provide same to another individual(s). It is further to be understood that the term “tablet” or “tablets” as used herein is intended to refer to ingestible products which include, for example, and not by way of limitation, tablets, pills, capsules, lozenges, gel caps and the like which are intended to be ingested in some form. Further, the term “ingestible product” is intended to include, for example, and not by way of limitation, vitamins, herbs, minerals, medicines (whether prescription or over-the-counter remedies), dietary supplements and additives, and the like. For ease of understanding, the term “container” is intended to include, for example, and not by way of limitation, container, vial, bottle, box, can, jar, package, packet, pouch, and the like in which ingestible products may be provided.

Embodiments provide informative closures for ingestible product containers that display dosage information in a clear, concise, easy-to-read manner which does not require the user to read fine print on the container label in an effort to hunt for the recommended dosage. Embodiments show how many of the ingestible product to ingest, and how many times per day to take that dosage. Embodiments do not use moving parts or require update by the user.

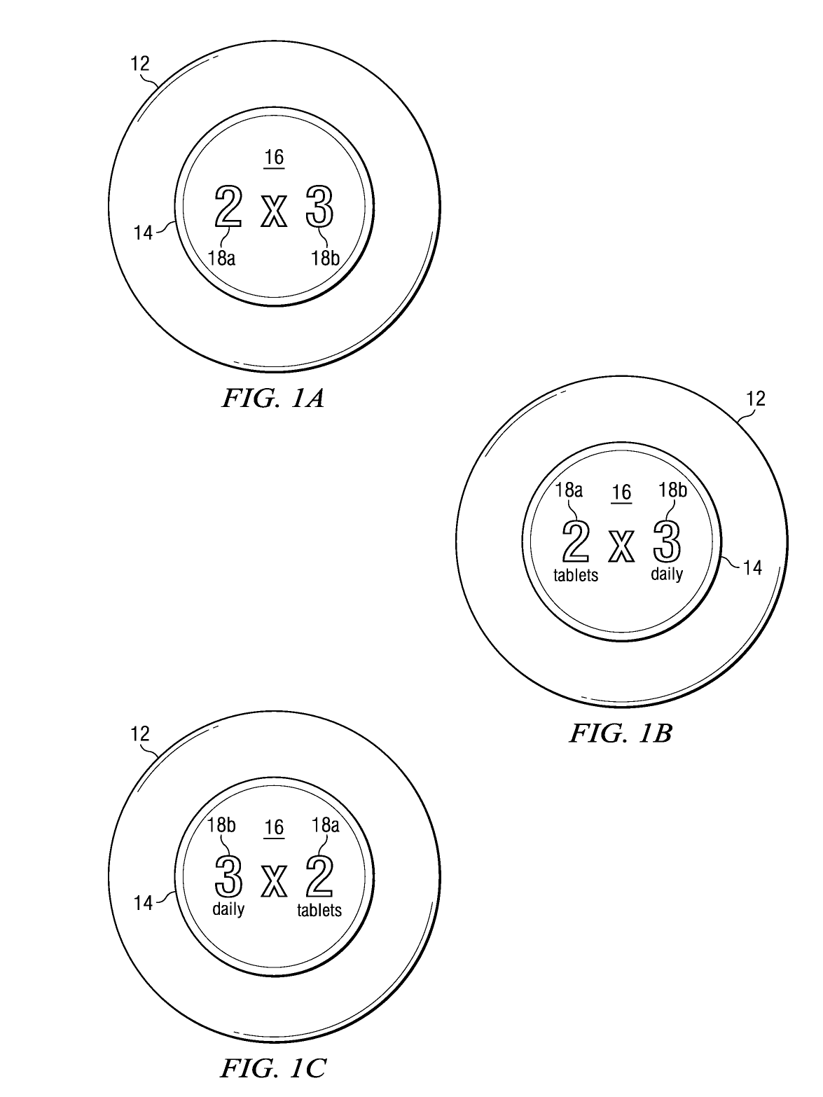

Consider now FIGS. 1A-1C which generically illustrate top plan views of example embodiments of closures for ingestible product containers. Each of FIGS. 1A-1C illustrate a closure body 14 configured and arranged to be removably mounted on a container 12, closure body 14 having a top surface 16. It should be appreciated that closure body 14 may be one of a variety of types of closure, including but not limited to child-resistant, snap-fit, rotatably mounted, etc. Moreover, closure body 14 may be constructed from a variety of materials, such as but not limited to polyethylene, polypropylene, polystyrene, polyvinyl chloride (PVC), or various metals including but not limited to steel, aluminum, copper, or any other non-reactive material; polypropylene is preferable. Indicia 18a and 18b are formed as part of top surface 16, indicia displaying a number of tablets to ingest (18a) and how many times per day the number of tablets are to be ingested (18b).

It should be observed at this point that despite the embodiments showing bottle-type containers, that containers may be a variety of shapes and sizes. Moreover, in the case of containers for dispensing liquid having doses per day dosing instructions, the indicia may be provided at any flat surface which is readily available. Thus, for the bottle-type containers, the top surface selected for discussion is also a readily available flat surface.

Consider FIG. 1A, indicium 18a displays the numeral 2 representing the number of tablets which should be ingested at each dosing; indicium 18b displays the numeral 3 representing how many times per day the number of tablets reflected by indicia 18a are to be ingested. FIG. 1B illustrates another embodiment. Specifically, container 12 with closure body 14 having top surface 16 displays indicia 18a and 18b. In this embodiment, indicium 18a indicates “2 tablets”, while indicium 18b indicates “3 daily”. Thus, a user seeing this displayed indicia would know to take 2 tablets three times daily, without having to resort to trying to read the label, or trying to locate their reading glasses to try to read the label. FIG. 1C illustrates yet another embodiment. Specifically, closure body 14 of container 12 has a top surface 16 displaying indicia 18a and 18b. In this embodiment, the order of the indicia have been reversed, namely how many times per day the dosage should be taken (18b) is listed before how many tablets per dose (18a).

While users rarely over-consume, they frequently under-consume or sometimes forget which ingestible products are to be taken at which meals, etc. With embodiments, however, if a user sees “3×2”, as a non-limiting example, they know 3 tablets are to be ingested twice daily, e.g., 3 tablets at breakfast and 3 tablets at dinner. As another illustrative non-limiting example, if a user sees “2×1” displayed on a closure, they know 2 tablets are to be ingested once a day.

While it should be appreciated that the word equivalent of the numerals may instead be used, e.g., “twice” or “two” instead of “2”, it is preferred that numerals are used at least because they are easier to readily comprehend, and literacy skill or knowledge of a specific language, e.g., English, is not required. It should be further understood that instead of the “x”, other symbols such as, for example, a colon, may be used instead to understandably separate the “how many” indicium from the “how often daily” indicium.

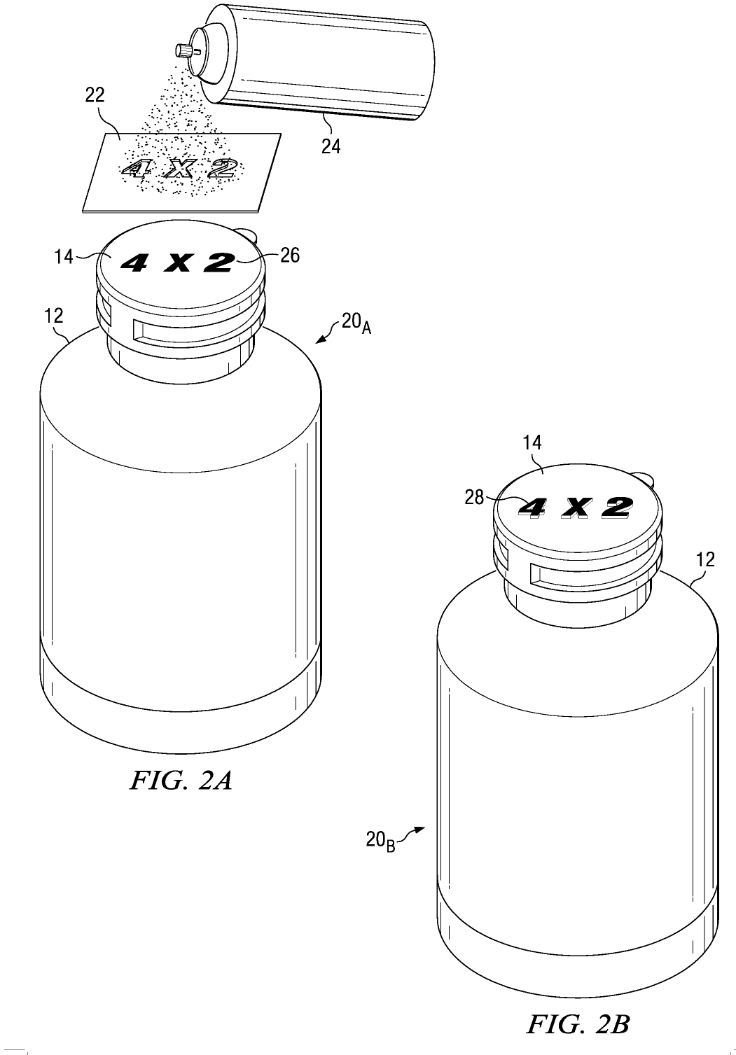

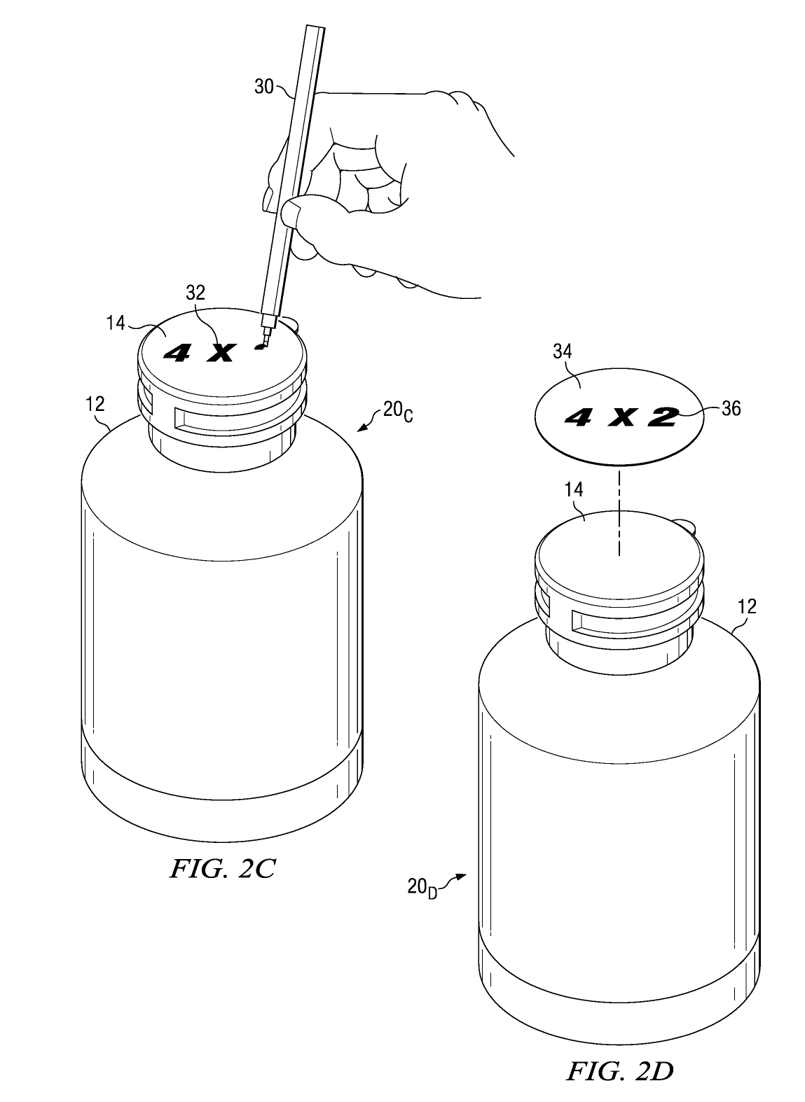

Turning now to FIGS. 2A-2D, various exemplary methods of providing indicia on closures are illustrated, according to embodiments. These methods enable the addition of large, easy-to-read text to display how many tablets and how often to take them daily to the closure of any container 12. It should be readily understood that embodiments may alternatively apply to any ingestible product dispensed from a box or spray bottle, for example, with dosing instructions.

FIG. 2A is a perspective view of an embodiment showing a method of providing indicia 26 as part of closure 14 of container 12 by means of a stencil 22. Spray pigmentation 24 may be applied across stencil 22 by any of a variety of processes now known or developed in the future, only one of which is shown for simplicity of understanding. It should be appreciated that the pigmentation is preferably a color which contrasts to the primary color of closure 14.

FIG. 2B is a perspective view of an embodiment illustrating the results of a method of providing indicia 28 as part of closure 14 of container 12 by means of a molded plastic lid, or by a hot press which presses the information into the lid. Given that many ingestible products have recommended dosing information that is normally the same for all consumers, the closures for such ingestible product containers are easily manufactured to provide the indicia as an integral part of the closures. Thus, and according to some embodiments, raised indicia 28 may be hot-pressed, molded or formed into closure 14 during manufacture and production using any of a variety of processes now known or later developed, which closure which will ultimately be secured to corresponding ingestible product containers. Alternatively, it may be appreciated that instead of raised indicia 28, the indicia may be indentedly pressed or molded into the top surface of closure 14. It should be further appreciated that closures should preferably be manufactured with contrasting indicia integrally formed therewith; specifically, the indicia should contrast in color from the primary color of the closure to promote ease of reading of indicia by a user.

FIG. 2C is a perspective view of an embodiment showing a method of providing indicia 32 as part of closure 14 of container 12 by means of writing indicia 32 onto the top surface of closure 14 by means of an indelible marker 30. Such method would be particularly useful in retrofitting ingestible containers a user has previously purchased, for example. While it should be understood that any type of marker may be used, an indelible marker is more practicable in the day-to-day use of containers.

FIG. 2D is a perspective view of an embodiment showing a method of providing indicia 36 as part of closure 14 of a container 12 by means of employing an adhesively adherable printed stick-on label 34. Embodiments of such method, when implemented by an ingestible products manufacturer, or a manufacturer of containers and closures for same, adhesively adherable label 34 is pre-printed with indicia 36; label 34 is subsequently adhered to closure 14 as it proceeds through the manufacturing process. According to other embodiments, adhesively adherable label 34 may be first adhered to closure 14 and then subsequently imprinted with indicia 36, as desired. Still other embodiments employ pre-printed sheets of adhesively adherable labels of identical or varying indicia whereby a post-production application by a pharmacist, pharmacologist or user to closure 14. Specifically, the individual selects a sticker from the sheet bearing the appropriate dosing indicia, removes the sticker from the sheet, and applies the selected sticker to closure 14.

It should be appreciated that in at least some embodiments, the size of the numerals and/or words forming the indicia are at least one font size larger than the size of the corresponding dosing information to be found on the container label.

In view of the present description of various embodiments, several advantages are achieved. For example, because the embodiments form a part of the closure body, none of them interfere with the opening of the closure, regardless of whether the closure is a “child-resistant” closure, a rotatably closing closure, a snap-fit closure, etc. Because embodiments do not require moving parts, or double-molded pieces, closures displaying the indicia are less expensive to manufacture, and is easy to employ by the user. Further, embodiments clearly display needed dosing information, regardless of whether implemented in a single ingestible product container or in a gathering of a plurality of such containers.

When a plurality of ingestible product types are to be ingested, the corresponding containers might be stored as a collection on a counter top, in a bowl, on a shelf, on a table, on a rotatable platform, plate or other conveyance, etc. such that there are numerous containers congregated in one place. Users normally congregate ingestible product containers in one place to avoid misplacing or forgetting one.

However, when there are multiple containers so grouped, it is easy to overlook one or more containers. With embodiments, a user can look at a top surface of a plurality of containers and quickly pick out which containers should be accessed and how many tablets to remove. As a non-limiting illustrative example, when it is breakfast, for example, all bottles are opened and the correct number of pills removed. Then, when it is lunch, all bottles with a “3” as the “how often daily” indicator are opened, the correct number of tablets removed and ingested. At dinner, in this illustrative, non-limiting example, all containers with a “2” or “3” displayed as the “how often daily” indicator are opened and the correct number of tables removed and ingested.

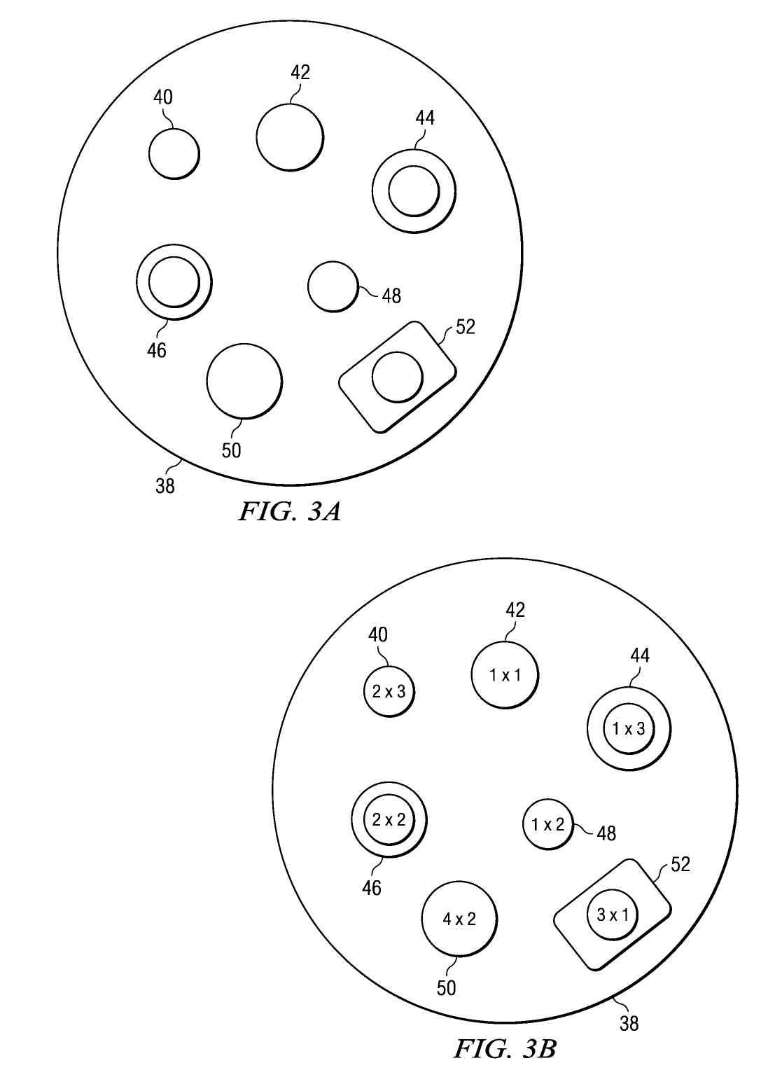

Consider FIGS. 3A and 3B. Both figures illustrate the identical hypothetical gathering of multiple ingestible product containers 38-52 situated at gathering location 30. As can readily be seen from viewing FIG. 3A, when looking at the accumulated assortment of containers, one is obliged to pick up each and every container to ascertain the correct dosage to determine whether or not the contents of that particular container need be ingested at this time, and if so, how many tablets. Compare now FIG. 3B with FIG. 3A; FIG. 3B displays the dosing indicia on the closure top surfaces of each container, according to at least some embodiments. Now, a user may quickly and accurately pluck the appropriate containers from the gathering location 30. If, for the sake of discussion, it is assumed that it is lunch time, the user would properly select containers 40 and 44, withdrawing 2 tablets from container 40 and 1 tablet from container 44. If instead, again for the sake of discussion, it is assumed that it is dinner time, the user would properly select containers 40, 44, 46, 48, and 50; withdrawing 2 tablets from container 40, 1 tablet from container 44, 2 tablets from container 46, one tablet from container 48, and 4 tablets from container 50. No other containers need be checked, and no concern as to not ingesting the correct number of tablets.

Many modifications and other embodiments of the invention will come to mind to one skilled in the art to which this invention pertains having the benefit of the teachings presented in the foregoing descriptions, and the associated drawings. Therefore, the above discussion is meant to be illustrative of the principles and various embodiments of the disclosure; it is to be understood that the invention is not to be limited to the specific embodiments disclosed. Although specific terms are employed herein, they are used in a generic and descriptive sense only and not for purposes of limitation. It is intended that the following claims be interpreted to embrace all such variations and modifications.

What is claimed is:

1. A closure for a container of ingestible product, comprising:
a closure body configured and arranged to be removably mounted on a container, the closure body including a top surface;
indicia formed as part of the closure body top surface, the indicia displaying a number of tablets to ingest and how many times per day the number of tablets are to be ingested.

2. The closure of claim 1, wherein at least some of the indicia are in a color contrasting with the closure body top surface.

3. The closure of claim 1, wherein a user does not update the indicia.

4. The closure of claim 1, wherein at least some of the indicia are integrally formed with the closure body top surface.

5. The closure of claim 4, wherein at least some of the indicia are raised with respect to the closure body top surface.

6. The closure of claim 4, wherein at least some of the indicia are indents with respect to the closure body top surface.

7. The closure of claim 1, wherein the indicia are formed on a stick-on label, the label adhesively attachable to the top surface to thereby form a part of the closure body top surface.

8. The closure of claim 1, wherein the indicia are formed by applying pigmentation across a stencil to thereby form a part of the closure body top surface.

9. The closure of claim 1, wherein a font size of at least some of the indicia is larger than a font size of corresponding dosing information on a label on the container.

10. A method for displaying indicia of dosing information for an ingestible product, comprising:
providing indicia formed as part of a top surface of a closure body, the closure body configured and arranged to be removably mounted to a container, the indicia displaying a number of tablets to ingest and how many times per day the number of tablets are to be ingested; and
displaying the indicia.

11. The method of claim 10, wherein the providing further comprises providing indicia by hot pressing the indicia into the closure, to thereby form the indicia as part of the top surface.

12. The method of claim 10, wherein the providing further comprises providing indicia by molding the closure to form raised indicia, to thereby form the indicia as part of the top surface.

13. The method of claim 10, wherein the providing further comprises providing indicia by adhesively attaching a label bearing the indicia to the top surface, to thereby form the indicia as part of the top surface.

14. The method of claim 10, wherein the providing further comprises providing indicia by applying pigmentation via a stencil onto the top surface, to thereby form the indicia as part of the top surface.

15. The method of claim 10, wherein the providing further comprises providing indicia by writing the indicia with an indelible marker onto the top surface, to thereby form the indicia as part of the top surface.

16. The method of claim 10, wherein the providing further comprises providing indicia which contrasts in color with the primary color of the top surface of the closure.

17. The method of claim 10, wherein the providing further comprises providing indicia such that a font size of at least some of the indicia is larger than a font size of corresponding dosing information on a label on the container.
